(19) United States
(12) Patent Application Publication
(10) Pub. No.: US 2024/0362049 A1
(43) Pub. Date: Oct. 31, 2024

(54) USING VIRTUAL MACHINE PRIVILEGE LEVELS TO CONTROL WRITE ACCESS TO KERNEL MEMORY IN A VIRTUAL MACHINE

(71) Applicant: Red Hat, Inc., Raleigh, NC (US)

(72) Inventor: Bandan Das, Westford, MA (US)

(21) Appl. No.: 18/306,698

(22) Filed: Apr. 25, 2023

(51) Int. Cl. G06F 9/455

(52) U.S. Cl. CPC G06F 9/45558; G06F 2009/45579; G06F 2009/45583

(57) ABSTRACT

Write access to kernel memory in a virtual machine (VM) can be controlled using virtual machine privilege levels (VMPLs). In one example, a guest kernel can detect an attempt by a device driver to perform a write operation using a first virtual central processing unit (vCPU) with a first VMPL. The write operation can correspond to a particular kernel memory address for the guest kernel, and the first VMPL may have fewer permissions than a second VMPL. In response to detecting the write operation, the guest kernel can exit to a hypervisor associated with the guest kernel based on the first VMPL. In response, the hypervisor can launch a second vCPU with the second VMPL. The second vCPU can determine that a range of kernel memory for the guest kernel does not comprise the particular kernel memory address. In response, the device driver, using the first vCPU, can execute the write operation.

### TECHNICAL FIELD

The present disclosure relates generally to virtual machines. More specifically, but not by way of limitation, this disclosure relates to using virtual machine privilege levels (VMPLs) to control write access to kernel memory in a virtual machine.

### BACKGROUND

Virtualization may be used to provide some physical components as logical objects in order to allow running various software modules, concurrently and in isolation from other software modules, on a computing device or a collection of connected computing devices. Virtualization may allow, for example, for consolidating multiple physical servers into one physical server running multiple guest virtual machines in order to improve the hardware utilization rate.

Virtualization may be achieved by running a software layer, often referred to as a hypervisor, to manage processor resources allocated to guest virtual machines. The hypervisor may virtualize the physical layer and provide interfaces between the underlying hardware and guest virtual machines and any guest operating systems. The hypervisor can use these interfaces to manage resources given to applications running on a guest virtual machine.

### BRIEF DESCRIPTION OF THE DRAWINGS

FIG. 1 is a block diagram of an example of a computing environment for using virtual machine privilege levels (VMPLs) to control write access to kernel memory in a virtual machine according to one example of the present disclosure.

FIG. 2 is a block diagram of another example of a computing environment for using VMPLs to control write access to kernel memory in a virtual machine according to one example of the present disclosure.

FIG. 3 is a flowchart of a process for using VMPLs to control write access to kernel memory in a virtual machine according to one example of the present disclosure.

### DETAILED DESCRIPTION

A physical computer system can include physical hardware running a hypervisor to manage a virtual machine. The virtual machine can include virtualized hardware that emulates the physical hardware, such as a virtual central processing unit (vCPU) or a virtualized storage device. The virtual machine can run one or more third-party device drivers using the virtualized hardware to provide a software interface to hardware devices, enabling an operating system of the physical computer system to access hardware functions. In some cases, the device drivers can be created by external entities. Code for such device drivers may lack rigorous testing that would minimize vulnerabilities (e.g., bugs, exploits, unpatched program code, etc.) in the code. For instance, device drivers are a major cause of kernel crashes and stalls. Many device drivers are run as kernel modules that are loaded at runtime and can have enough access to the kernel space to cause damage. If a device driver can access critical infrastructure for the kernel, the vulnerabilities associated with this device driver may stall or fail the entire physical computer system.

Some examples of the present disclosure can overcome one or more of the issues mentioned above by using virtual machine privilege levels (VMPLs) to control write access of the device drivers running in the virtual machine. Specifically, guest memory of the physical computer system can be partitioned to prevent unauthorized access by the device drivers. When launching vCPUs to run the device drivers, the hypervisor can use different virtual machine control structures corresponding to different VMPLs. Each VMPL may have different permissions associated with accessing or interacting with the guest memory of the physical computer system. This enables a guest kernel of the virtual machine to prevent the unauthorized access of the device drivers by running more than one vCPU with different VMPLs such that untrusted device drivers are executed using a vCPU with relatively few permissions.

Typically, the guest kernel may assume that the hypervisor is unable to harm the guest memory such that the guest kernel provides guest-specific security requirements to the hypervisor to control access to the guest memory. By instead enabling the guest kernel to control access to the guest memory, the hypervisor can be minimally involved in restricting access of the device drivers, thereby enabling the guest kernel to avoid trusting the hypervisor unnecessarily. Specifically, before the hypervisor launches the virtual machine, the hypervisor can configure the guest memory range with the VMPLs such that the virtual machine can control access to the guest memory. For instance, the guest kernel can configure (e.g., enable or disable) the permissions associated with a device driver by modifying a corresponding VMPL of a vCPU used to run the device driver.

In one particular example, a first vCPU used to load the device drivers can have fewer permissions (e.g., read and execute access, but no write access) than a second vCPU of the virtual machine. For instance, a guest kernel can run the first vCPU using a high-level VMPL and the second vCPU using a low-level VMPL. The high-level VMPL may have fewer permissions compared to the low-level VMPL, such as having read and execute permissions but not write permission. If a device driver attempts a write operation to any memory location, such as a kernel memory address, of the guest memory, the virtual machine can exit to the hypervisor. A hypervisor can run the second vCPU (which has more permissions than the first vCPU) to determine whether the write operation is allowable. The second vCPU can use a trusted code base in the guest kernel to determine allowability of the write operation of the device driver. Once the write operation is deemed allowable, the hypervisor can relaunch the first vCPU, enabling the device driver to complete the write operation. Specifically, the trusted code base can be used to determine whether the memory location of the write operation corresponds to a range of kernel memory that is associated with critical memory data structures. In this way, the guest kernel can prevent unauthorized access of device drivers to critical infrastructure of the physical computer system.

If the memory location does not correspond to the range of kernel memory, the low-level VMPL can use an instruction to modify permissions of the high-level VMPL to include write access for this memory location. The trusted code base can include another virtual machine exit to the hypervisor in response to modifying the permissions of the high-level VMPL. Once the hypervisor relaunches the vCPU with the high-level VMPL, the device driver can complete the write operation to the kernel memory address. Alternatively, if the kernel memory address is included in the range of kernel memory, the trusted code base may deny the write operation and output an error code that causes the guest kernel to exit to the hypervisor. The hypervisor then can relaunch the vCPU with the high-level VMPL such that write access to the kernel memory address remains restricted with respect to the device driver.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

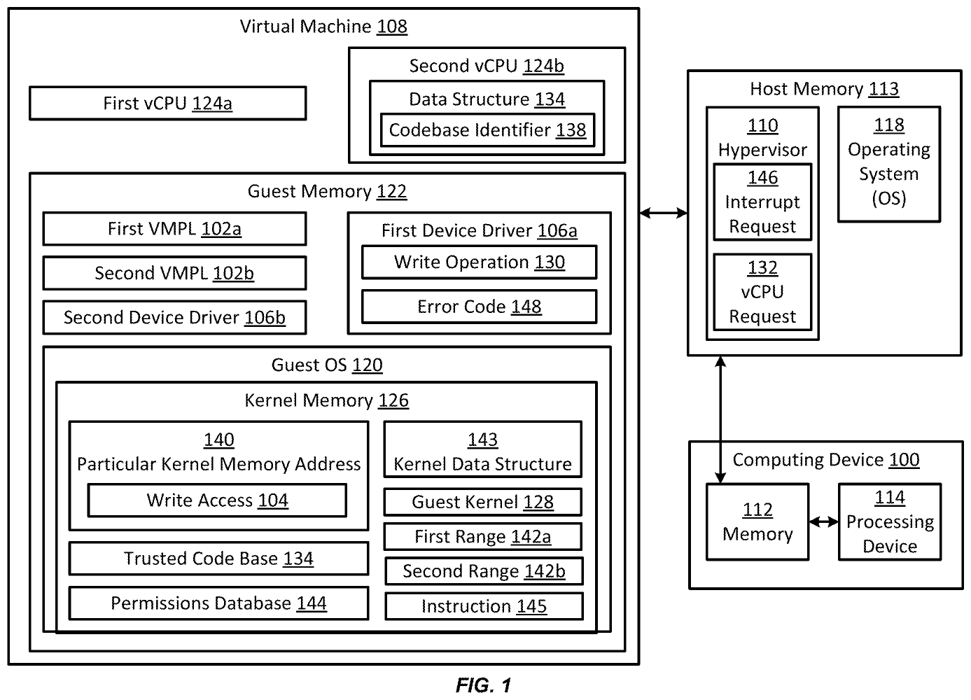

FIG. 1 is a block diagram of an example of a computing device 100 for using virtual machine privilege levels (VMPLs) 102a-b to control write access 104 to kernel memory 126 in a virtual machine 108 according to one example of the present disclosure. In some examples, the computing device 100 can use the VMPLs 102a-b to control the write access 104 of one or more device drivers 106a-b to the kernel memory. Examples of the computing device 100 can include a desktop computer, laptop computer, server, mobile phone, or tablet. The computing device 100 can execute software as defined below, which can cause the computing device 100 to perform the tasks of providing a hypervisor 110 in memory 112 that resides in host memory 113. The computing device 100 can include a processing device 114 communicatively coupled to the memory 112 to perform operations based on instructions in the memory 112. Additionally, the computing device 100 can run the virtual machine 108 by executing a hypervisor 116 and an operating system (OS) 118. The OS 118 can have a monolithic kernel architecture such that the OS 118 runs in kernel space. In some examples, the OS 118 can execute the hypervisor 116. Alternatively, the OS 118 can execute the hypervisor 116 separately from, or exclusive of, the OS 118.

The hypervisor 116 can virtualize a physical layer of the computing device 100, including processors, memory devices, I/O devices, and the like and present this virtualization to the virtual machine 108 as devices, including virtual processors, virtual memory devices, and virtual I/O devices. The virtual machine 108 may run any type of dependent, independent, or compatible applications on the underlying hardware and OS 118. In this example, the virtual machine 108 is executing a guest OS 120 that resides in guest memory 122, which may utilize underlying hardware (e.g., a virtual central processing unit (vCPU) 124) to run software, such as the device drivers 106a-b. The guest OS 120 additionally can include a kernel memory 126 that stores data structures related to a guest kernel 128 responsible for performing operations of the guest OS 120.

The device drivers 106a-b running using the guest memory 122 can include one or more files that enable the hardware to communicate with the OS 118 of the computing device 100. In some examples, the device drivers 106a-b can be associated with external entities such that the device drivers 106a-b may be untrusted by the computing device 100 due to a relatively high likelihood of containing vulnerabilities. To mitigate a security risk associated with using a first device driver 106a, the guest kernel can use a first vCPU 124a with a first VMPL 102a to run the first device driver 106a. The guest kernel can assign the first VMPL 102a to the first device driver 106a due to the first VMPL 102a having fewer permissions compared to a second VMPL 102b. The first VMPL 102a can be a first-level VMPL (e.g., VMPL1) and the second VMPL 102b can be zeroth-level VMPL (e.g., VMPL0). For example, the first VMPL 102a may grant read access and execute access to the first vCPU 124a but may not allow write access 104 to the kernel memory 126. As a result, unless the guest kernel 128 grants the write access 104 to the first device driver 106a, the first device driver 106a is unable to perform a write operation 130 to the kernel memory 126. Thus, the guest kernel 128 can prevent or mitigate unauthorized write operations by the first device driver 106a to improve device security for the computing device 100.

Assigning the first VMPL 102a to the first device driver 106a can involve the guest kernel 128 transmitting a vCPU request 132 that includes the first VMPL 102a to the hypervisor 110. Once the hypervisor 110 receives this vCPU request 132, the hypervisor 110 can use the first VMPL 102a included in the vCPU request 132 to determine a suitable vCPU with the first VMPL 102a. After determining that the first vCPU 124a is associated with the first VMPL 102a, the guest kernel 128 can assign the first vCPU 124a to run the first device driver 106a.

The first device driver 106a attempting the write operation 130 can cause an exception that results in the guest kernel 128 exiting to the hypervisor 110. Prior to exiting to the hypervisor 110, the first vCPU 124a can store an exit location associated with device driver code of the first device driver 106a that designates where in the device driver code the first vCPU 124a stopped. This can allow the first vCPU 124a to restart the first device driver 106a at the exit location at a later time if the first vCPU 124a gets relaunched at the later time. After the guest kernel 128 exits to the hypervisor 110, the hypervisor 110 can launch a second vCPU 214b with the second VMPL 102b to determine allowability of the write operation 130.

Specifically, using the second vCPU 124b to determine the allowability of the write operation 130 can involve executing a trusted code base (TCB) 134 that is associated with the second vCPU 124b. To execute the TCB 134, the guest kernel 128 can access, using the second vCPU 124b, a data structure 136 of the second vCPU 124B to determine a codebase identifier 138 associated with the TCB 134 and usable to identify the TCB 134 in storage. In some examples, the TCB 134 can be stored in the guest memory 122 or the kernel memory 126. The TCB 134 can include one or more functions that can determine allowability of the write operation 130. For example, the functions can be used to determine whether a particular kernel memory address 140 of the write operation 130 corresponds to a first range 142a of the kernel memory 126 that is associated with critical memory data structures. For example, the range 142 of the kernel memory 126 corresponding to the critical memory structures may include 0x1000 to 0x2000 of the kernel memory 126. The guest kernel 128 can search this range 142 of the kernel memory 126 to determine whether the range 142 includes the particular kernel memory address 140.

Additionally, the functions of the TCB 134 can identify the particular kernel memory address 140 as being associated with the first device driver 106a, for example in a kernel data structure 143 of the guest kernel 128. The kernel data structure 143 can map a subset of the kernel memory 126 to a respective device driver 106 to designate ownership of the subset of the kernel memory 126. Once the particular kernel memory address 140 has this designation, the guest kernel 128 can prevent a second device driver 106b from writing to the particular kernel memory address 140 based on the designation of the particular kernel memory address 140. In some examples, assigning the designation of the particular kernel memory address 140 additionally may involve designating ownership of a memory page corresponding to the particular kernel memory address 140. The memory page can be stored in a page table and be used as part of memory management to record or control sharing of memory resources associated with the computing device 100.

If the guest kernel 128, using the TCB 134, determines that the write operation 130 is allowable, the guest kernel 128 can use the TCB 134 to modify the write access 104 to the particular kernel memory address 140. Specifically, the guest kernel 128 may use the TCB 134 to confirm one or more prerequisite conditions, for example that the first VMPL 102a has fewer permissions compared to the second VMPL 102b. If the prerequisite conditions are not met, the guest kernel 128 may be unable to use the second vCPU 124b to modify the write access 104 of the first vCPU 124a. The guest kernel 128 can access a permissions database 144 (e.g., an RDX register) associated with the first VMPL 102a based on an instruction 145 (e.g., RMPADJUST) to modify one or more permissions of the permissions database 144.

After modifying the write access 104, the guest kernel 128, using the TCB 134, can issue an interrupt request 146 (e.g., a hypercall) that causes the guest kernel 128 to exit to the hypervisor 110. The hypervisor 110 then can relaunch the first vCPU 124a with the first VMPL 102a such that the first vCPU 124a restarts the first device driver 106a based on the exit location of the device driver code associated with the first device driver 106a. Once the first device driver 106a restarts, the first device driver 106a can complete the write operation 130 to the particular kernel memory address 140.

If the guest kernel 128, using the TCB 134, determines that the write operation 130 is unallowable or impermissible, the guest kernel 128 can output an error code 148, for example to the first device driver 106a. Once the guest kernel 128 outputs the error code 148, the guest kernel 128 may exit to the hypervisor 110 such that the hypervisor 110 can relaunch the first vCPU 124a to resume operation of the first device driver 106a. If the first device driver 106a receives the error code 148, the first device driver 106a then may determine a suitable action, such as failing or attempting the write operation 130 again.

In some examples, the guest kernel 128 may determine that the write operation 130 is unallowable due to the particular kernel memory address 140 of the write operation 130 being included in the first range 142a of the kernel memory 126. Alternatively, the write operation 130 may be unallowable because the particular kernel memory address 140 of the write operation 130 is associated with a second range 142b of the kernel memory 126 that corresponds to the second device driver 106b. For example, prior to the first device driver 106a attempting the write operation 130 to the particular kernel memory address 140, the second device driver 106b may have already completed another write operation to this particular kernel memory address 140. Thus, an owner of this second range 142b may be designated as the second device driver 106b in the kernel data structure 143 of the guest kernel 128. Due to this existing ownership of the particular kernel memory address 140, the guest kernel 128 can prevent the first device driver 106a from completing the write operation 130 by denying the write access 104 of the first device driver 106a.

While FIG. 1 depicts a specific arrangement of components, other examples can include more components, fewer components, different components, or a different arrangement of the components shown in FIG. 1. For instance, in other examples, the guest memory 122 may include more than two vCPUs 124 that each have a corresponding VMPL 102. Additionally, any component or combination of components depicted in FIG. 1 can be used to implement the process(es) described herein.

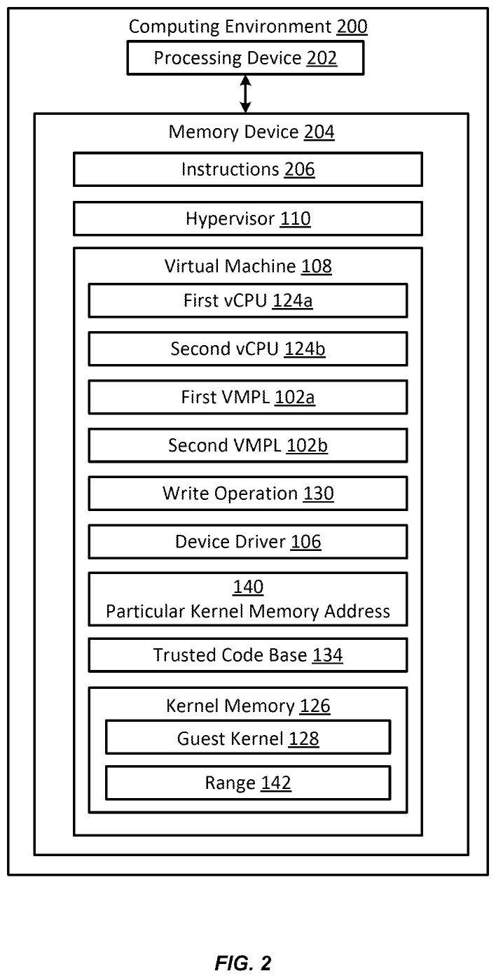

FIG. 2 is a block diagram of another example of a computing environment 200 for using virtual machine privilege levels (VMPLs) 102a-b to control write access 104 to kernel memory 126 in a virtual machine 108 according to one example of the present disclosure. The computing environment 200 can include a processing device 202 communicatively coupled to a memory device 204. In some examples, the processing device 202 can be the processing device 114 of FIG. 1. Similarly, the memory device 204 may be the memory 112 of FIG. 1.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

In some examples, the processing device 202 can use a guest kernel 128 of a virtual machine (VM) 108 to detect a write operation 130 attempted by a device driver 106. The processing device 202 may run the device driver 106 using a first virtual central processing unit (vCPU) 124a with a first virtual machine privilege level (VMPL) 102a that has fewer permissions than a second VMPL 102b. The processing device 202 may use the first vCPU 124a to run the device driver 106 due to security concerns, for example in response to determining that the device driver 106 is associated with an external entity or a third-party entity. Once the processing device 202 detects the write operation 130, the processing device 202 can perform a VM exit to a hypervisor 110 associated with the guest kernel 128. The hypervisor can be configured to launch a second vCPU 124b with the second VMPL 102b that can determine whether the write operation 130 is allowable.

The write operation 130 of the device driver 106 can correspond to a particular kernel memory address 140 of the guest kernel 128. In some examples, this particular kernel memory address 140 can be included in a range 142 of kernel memory 126 for the guest kernel 128 that is associated with critical memory structure. Accordingly, the processing device 202 may prevent the device driver 106 from performing the write operation 130 to this particular kernel memory address 140 by denying the write operation 130 due to the write operation 130 being unallowable. Alternatively, the processing device 202, using the second vCPU, may determine that the particular kernel memory address 140 associated with the write operation 130 is outside of the range 142 of the kernel memory 126 for the guest kernel 128. In response, the processing device 202 can adjust the write access to the particular kernel memory address 140 such that the device driver 106, through the first vCPU 124a, can complete the write operation 130.

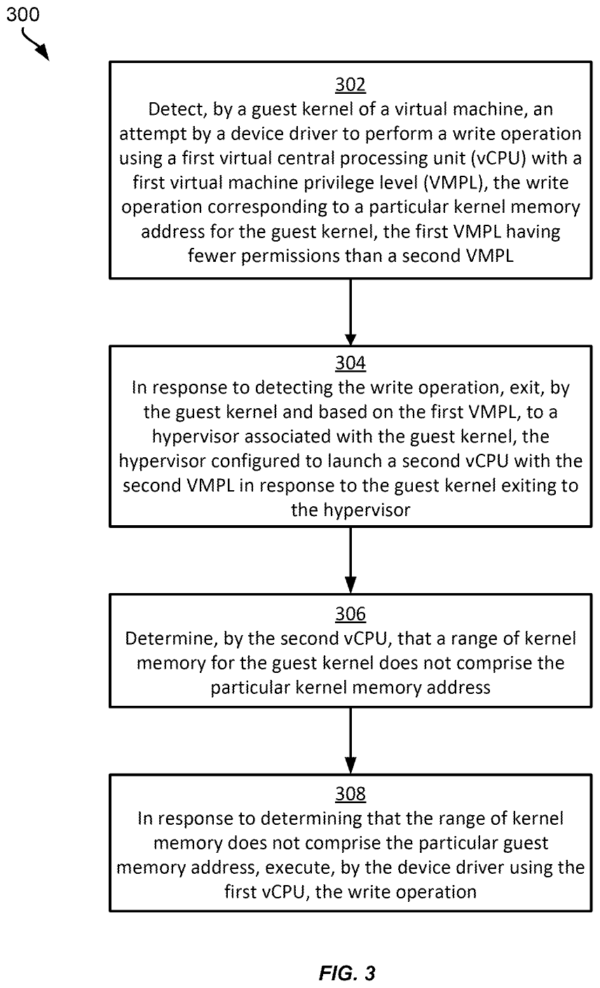

FIG. 3 is a flowchart of a process 300 for using virtual machine privilege levels (VMPLs) 102a-b to control write access 104 to kernel memory 126 in a virtual machine 108 according to one example of the present disclosure. In some examples, the processing device 202 can perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

In block 302, the processing device 202 detects, by a guest kernel 128 of the virtual machine (VM) 108, an attempt by a device driver 106 to perform a write operation 130 using a first virtual central processing unit (vCPU) 124a with a first VMPL 102a (e.g., VMPL1). The write operation 130 can correspond to a particular kernel memory address 140 for the guest kernel 128. Additionally, the first VMPL 102a may have fewer permissions than a second VMPL 102b (e.g., VMPL0). For example, the first VMPL 102a can include read and execute permissions, whereas the second VMPL 102b may include read, execute, and write permissions. The processing device 202 can use the first vCPU 124a to run untrusted software, such as the device driver 106, to improve data security and minimize risk associated with vulnerabilities.

In block 304, in response to detecting the write operation 130, the processing device 202 exits, by the guest kernel 128 and based on the first VMPL 102a, to a hypervisor 110 associated with the guest kernel 128. The hypervisor 110 may launch a second vCPU 124b with the second VMPL 102b in response to the guest kernel 128 exiting to the hypervisor 110. Because the second VMPL 102b has more permissions compared to the first VMPL 102a, the second vCPU 124b can have modification authority with respect to granting the write access of the first VMPL 102a. This enables the processing device 202 to use the second vCPU 124b to modify the write access 104 of the device driver 106 to the particular kernel memory address 140. In block 306, the processing device 202 determines that a range 142 of kernel memory 126 for the guest kernel 128 does not comprise the particular kernel memory address 140. Specifically, the processing device 202 can use the second vCPU 124b with the second VMPL 102b to search the range 142 of the kernel memory 126 with respect to the particular kernel memory address 140. The processing device 202 can determine whether the range 142 includes the particular kernel memory address 140. Additionally, the processing device 202 can designate the particular kernel memory address 140 as being associated with the device driver 106 in a kernel data structure 143 of the guest kernel 128. For example, the processing device 202 can use metadata in the kernel data structure 143 to designate an owner (e.g., the device driver 106) of the particular kernel memory address 140. Additionally, the metadata can be used to identify that the particular kernel memory address 140 is associated with an external entity, for example to pinpoint potential sources of vulnerability associated the kernel memory 126. Once the processing device 202 determines that the range 142 of the kernel memory 126 does not include the particular kernel memory address 140, the processing device 202 can execute an instruction 145 to grant the write access 104 to the device driver 106. Specifically, the processing device 202, using the instruction 145, can access a permissions database 144 associated with the first VMPL 102a to modify the write access 104 to the particular kernel memory address 140 with respect to the first VMPL 102a.

In block 308, in response to determining the range 142 of the kernel memory 126 does not comprise the particular kernel memory address 140, the processing device 202 executes, by the device driver 106 using the first vCPU 124a, the write operation 130. Once the write access 104 is modified, the processing device 202 can perform another VM exit to the hypervisor 110, enabling the hypervisor 110 to relaunch the first vCPU 124a such that the device driver 106 can complete the write operation 130. In some examples, the processing device 202 may perform this other VM exit in response to an interrupt request (e.g., a hypercall or another suitable calling mechanism) outputted by the processing device 202.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
detecting, by a guest kernel of a virtual machine (VM), an attempt by a device driver to perform a write operation using a first virtual central processing unit (vCPU) with a first virtual machine privilege level (VMPL), the write operation corresponding to a particular kernel memory address for the guest kernel, the first VMPL having fewer permissions than a second VMPL;
in response to detecting the write operation, exiting, by the guest kernel and based on the first VMPL, to a hypervisor associated with the guest kernel, the hypervisor configured to launch a second vCPU with the second VMPL in response to the guest kernel exiting to the hypervisor;
determining, by the second vCPU, that a range of kernel memory for the guest kernel does not comprise the particular kernel memory address; and
in response to determining that the range of kernel memory does not comprise the particular guest memory address, executing, by the device driver using the first vCPU, the write operation.

2. The system of claim 1, wherein the operations further comprise, in response to determining that the range of kernel memory does not comprise the particular kernel memory address:
modifying, by the guest kernel, a write access corresponding to the particular kernel memory address with respect to the first VMPL to enable the device driver to execute the write operation.

3. The system of claim 2, wherein modifying the write access further comprises:
designating the particular kernel memory address as being associated with the device driver in a kernel data structure of the guest kernel; and
executing an instruction to modify the write access to the particular kernel memory address with respect to the first VMPL, wherein the instruction involves accessing a permissions database associated with the first VMPL and modifying the permissions database to enable the write access of the first vCPU with the first VMPL.

4. The system of claim 1, wherein the operations further comprise, in response to determining that the range of kernel memory does not comprise the particular kernel memory address:
outputting, by the second vCPU, an interrupt request; and
in response to outputting the interrupt request, exiting, by the guest kernel, to the hypervisor, wherein the hypervisor is configured to launch the first vCPU with the first VMPL to complete the write operation.

5. The system of claim 1, wherein the range of kernel memory is a first range of kernel memory, and the device driver is a first device driver, and wherein the operations further comprise, subsequent to launching the second vCPU:
identifying a kernel data structure included in the guest kernel, wherein the kernel data structure is configured to map kernel memory to a respective device driver, and wherein determining that the range of kernel memory for the guest kernel does not comprise the particular kernel memory address further comprises:
determining, by accessing the kernel data structure, that the particular kernel memory address of the write operation attempted by the first device driver is associated with a second range of kernel memory corresponding to a second device driver; and
in response to determining that the particular kernel memory address corresponds to the second range of kernel memory, transmitting an error code to the first device driver, wherein the error code is configured to restrict write access of the first device driver to the second range of kernel memory.

6. The system of claim 1, wherein the operations further comprise, prior to detecting the write operation attempted by the device driver:
assigning, by the guest kernel, the first VMPL to the device driver, wherein the first VMPL is configured to prevent the device driver from executing the write operation;
transmitting, by the guest kernel, a vCPU request including the first VMPL to the hypervisor, wherein in response to receiving the vCPU request, the hypervisor is configured to determine that the first vCPU is associated with the first VMPL; and
in response to determining that the first vCPU is associated with the first VMPL, executing, by the guest kernel, the device driver using the first vCPU.

7. The system of claim 1, wherein the operations further comprise, prior to determining that the range of kernel memory for the guest kernel does not comprise the particular kernel memory address:
accessing, by the second vCPU, a data structure of the second vCPU to determine a codebase identifier associated with a TCB configured to determine allowability of the write operation to the particular kernel memory address, wherein the codebase identifier is usable to identify the TCB stored in the guest kernel.

8. A method comprising:
detecting, by a guest kernel of a virtual machine (VM), an attempt by a device driver to perform a write operation using a first virtual central processing unit (vCPU) with a first virtual machine privilege level (VMPL), the write operation corresponding to a particular kernel memory address for the guest kernel, the first VMPL having fewer permissions than a second VMPL;
in response to detecting the write operation, exiting, by the guest kernel and based on the first VMPL, to a hypervisor associated with the guest kernel, the hypervisor configured to launch a second vCPU with the second VMPL in response to the guest kernel exiting to the hypervisor;
determining, by the second vCPU, that a range of kernel memory for the guest kernel does not comprise the particular kernel memory address; and
in response to determining that the range of kernel memory does not comprise the particular guest memory address, executing, by the device driver using the first vCPU, the write operation.

9. The method of claim 8, further comprising, in response to determining that the range of kernel memory does not comprise the particular kernel memory address:
modifying, by the guest kernel, a write access corresponding to the particular kernel memory address with respect to the first VMPL to enable the device driver to execute the write operation.

10. The method of claim 9, wherein modifying the write access further comprises:
designating the particular kernel memory address as being associated with the device driver in a kernel data structure of the guest kernel; and
executing an instruction to modify the write access to the particular kernel memory address with respect to the first VMPL, wherein the instruction involves accessing a permissions database associated with the first VMPL and modifying the permissions database to enable the write access of the first vCPU with the first VMPL.

11. The method of claim 8, further comprising, in response to determining that the range of kernel memory does not comprise the particular kernel memory address:
outputting, by the second vCPU, an interrupt request; and
in response to outputting the interrupt request, exiting, by the guest kernel, to the hypervisor, wherein the hypervisor is configured to launch the first vCPU with the first VMPL to complete the write operation.

12. The method of claim 8, wherein the range of kernel memory is a first range of kernel memory, and the device driver is a first device driver, and wherein the method further comprises, subsequent to launching the second vCPU:
identifying a kernel data structure included in the guest kernel, wherein the kernel data structure is configured to map kernel memory to a respective device driver, and wherein determining that the range of kernel memory for the guest kernel does not comprise the particular kernel memory address further comprises:
determining, by accessing the kernel data structure, that the particular kernel memory address of the write operation attempted by the first device driver is associated with a second range of kernel memory corresponding to a second device driver; and
in response to determining that the particular kernel memory address corresponds to the second range of kernel memory, transmitting an error code to the first device driver, wherein the error code is configured to restrict write access of the first device driver to the second range of kernel memory.

13. The method of claim 8, further comprising, prior to detecting the write operation attempted by the device driver:
assigning, by the guest kernel, the first VMPL to the device driver, wherein the first VMPL is configured to prevent the device driver from executing the write operation;
transmitting, by the guest kernel, a vCPU request including the first VMPL to the hypervisor, wherein in response to receiving the vCPU request, the hypervisor is configured to determine that the first vCPU is associated with the first VMPL; and
in response to determining that the first vCPU is associated with the first VMPL, executing, by the guest kernel, the device driver using the first vCPU.

14. The method of claim 8, further comprising, prior to determining that the range of kernel memory for the guest kernel does not comprise the particular kernel memory address:
accessing, by the second vCPU, a data structure of the second vCPU to determine a codebase identifier associated with a TCB configured to determine allowability of the write operation to the particular kernel memory address, wherein the codebase identifier is usable to identify the TCB stored in the guest kernel.

15. A non-transitory computer-readable medium comprising program code executable by a processing device for causing the processing device to perform operations comprising:
detecting, by a guest kernel of a virtual machine (VM), an attempt by a device driver to perform a write operation using a first virtual central processing unit (vCPU) with a first virtual machine privilege level (VMPL), the write operation corresponding to a particular kernel memory address for the guest kernel, the first VMPL having fewer permissions than a second VMPL;
in response to detecting the write operation, exiting, by the guest kernel and based on the first VMPL, to a hypervisor associated with the guest kernel, the hypervisor configured to launch a second vCPU with the second VMPL in response to the guest kernel exiting to the hypervisor;
determining, by the second vCPU, that a range of kernel memory for the guest kernel does not comprise the particular kernel memory address; and
in response to determining that the range of kernel memory does not comprise the particular guest memory address, executing, by the device driver using the first vCPU, the write operation.

16. The non-transitory computer-readable medium of claim 15, wherein the operations further comprise, in response to determining that the range of kernel memory does not comprise the particular kernel memory address:
modifying, by the guest kernel, a write access corresponding to the particular kernel memory address with respect to the first VMPL to enable the device driver to execute the write operation.

17. The non-transitory computer-readable medium of claim 16, wherein modifying the write access further comprises:
designating the particular kernel memory address as being associated with the device driver in a kernel data structure of the guest kernel; and
executing an instruction to modify the write access to the particular kernel memory address with respect to the first VMPL, wherein the instruction involves accessing a permissions database associated with the first VMPL and modifying the permissions database to enable the write access of the first vCPU with the first VMPL.

18. The non-transitory computer-readable medium of claim 15, wherein the operations further comprise, in response to determining that the range of kernel memory does not comprise the particular kernel memory address:
outputting, by the second vCPU, an interrupt request; and
in response to outputting the interrupt request, exiting, by the guest kernel, to the hypervisor, wherein the hypervisor is configured to launch the first vCPU with the first VMPL to complete the write operation.

19. The non-transitory computer-readable medium of claim 15, wherein the range of kernel memory is a first range of kernel memory, and the device driver is a first device driver, and wherein the operations further comprise, subsequent to launching the second vCPU:
identifying a kernel data structure included in the guest kernel, wherein the kernel data structure is configured to map kernel memory to a respective device driver, and wherein determining that the range of kernel memory for the guest kernel does not comprise the particular kernel memory address further comprises:
determining, by accessing the kernel data structure, that the particular kernel memory address of the write operation attempted by the first device driver is associated with a second range of kernel memory corresponding to a second device driver; and
in response to determining that the particular kernel memory address corresponds to the second range of kernel memory, transmitting an error code to the first device driver, wherein the error code is configured to restrict write access of the first device driver to the second range of kernel memory.

20. The non-transitory computer-readable medium of claim 15, wherein the operations further comprise, prior to detecting the write operation attempted by the device driver:
assigning, by the guest kernel, the first VMPL to the device driver, wherein the first VMPL is configured to prevent the device driver from executing the write operation;
transmitting, by the guest kernel, a vCPU request including the first VMPL to the hypervisor, wherein in response to receiving the vCPU request, the hypervisor is configured to determine that the first vCPU is associated with the first VMPL; and
in response to determining that the first vCPU is associated with the first VMPL, executing, by the guest kernel, the device driver using the first vCPU.
